(19) United States
(12) Patent Application Publication
(10) Pub. No.: US 2017/0303328 A1
(43) Pub. Date: Oct. 19, 2017

(54) ANTENNA WEIGHT VECTOR GROUP IDENTIFICATION FOR WIRELESS COMMUNICATION

(71) Applicant: Intel IP Corporation, Santa Clara, CA (US)

(72) Inventors: Laurent Cariou, Portland, OR (US); Carlos Cordeiro, Portland, OR (US); Assaf Kasher, Haifa (IL)

(73) Assignee: Intel IP Corporation, Santa Clara, CA (US)

(21) Appl. No.: 15/392,382

(22) Filed: Dec. 28, 2016

Related U.S. Application Data
(60) Provisional application No. 62/323,381, filed on Apr. 15, 2016.

(51) Int. Cl. H04W 76/02; H04B 7/04; H04B 7/06; H04B 7/08; H04L 29/08; H04W 84/12

(52) U.S. Cl. CPC H04W 76/025; H04B 7/0851; H04L 67/1044; H04B 7/0452; H04B 7/0654; H04W 84/12

(57) ABSTRACT

Wireless communication networks may use various techniques, including those that use multiple-access techniques such as multi-user multiple-input multiple-output (MU-MIMO) techniques. In some embodiments, the use of a MU-MIMO setup frame may give a destination STA a chance to select a best antenna weight vector (AWV) based on previous antenna training. In particular, the use of an AWVgroupID may be used to identify a group of one or more STAs that can be the destination STAs of the MU-MIMO setup frame.

### CROSS REFERENCE TO RELATED APPLICATIONS

This application is derived from U.S. provisional application Ser. No. 62/323,381, filed Apr. 15, 2016, and claims priority to that date for all applicable subject matter.

### TECHNICAL FIELD

Some embodiments may pertain to wireless networks and wireless communications. Some embodiments may relate to wireless local area networks (WLANs) and Wi-Fi networks including networks operating in accordance with the IEEE 802.11 family of wireless communication standards. For example, some embodiments may relate to IEEE standard 802.11ay. Some embodiments may relate to methods, computer readable media, apparatus, or systems for antenna weight vector group identification.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols to and with legacy device protocols.

### BRIEF DESCRIPTION OF THE DRAWINGS

Some embodiments of the invention may be better understood by referring to the following description and accompanying drawings that are used to illustrate embodiments of the invention. The present disclosure is illustrated by way of example and not limitation in the figures of the accompanying drawings, in which like references indicate similar elements and in which:

FIG. 1 illustrates a WLAN in accordance with some embodiments.

FIGS. 2A and 2B illustrate multiple user (MU) multiple input multiple output (MIMO) protocol data unit (PPDU) communication in accordance with some embodiments, some of which may conform to IEEE standard 802.11ay.

FIG. 3 illustrates a MIMO setup frame that can be transmitted to a STA, where the MIMO setup frame includes several STA AIDs in accordance with some embodiments. This may increase the flexibility of groupings in the MU-MIMO setup frame.

FIG. 4 illustrates a MIMO setup frame that can be transmitted to a STA, where the MIMO setup frame includes an AWVID to identify which AWV the STA can use, in accordance with some embodiments.

FIG. 5 illustrates a block diagram of an example machine upon which any one or more of the techniques (e.g., methodologies) discussed herein may perform, in accordance with some embodiments.

FIG. 6 shows a flow diagram of a method, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

References to ‘one embodiment’, ‘an embodiment’, ‘example embodiment’, ‘various embodiments’, etc., indicate that the embodiment(s) of the invention so described may include particular features, structures, or characteristics, but not every embodiment necessarily includes those particular features, structures, or characteristics. Further, some embodiments may have some, all, or none of the features described for other embodiments.

As used in the claims, unless otherwise specified the use of the ordinal adjectives ‘first’, ‘second’, ‘third’, etc., to describe a common element, merely indicate that different instances of like elements are being referred to, and are not intended to imply that the elements so described must be in a given sequence, either temporally, spatially, in ranking, or in any other manner.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term ‘wireless’ may be used to describe circuits, devices, systems, methods, techniques, communications channels, etc., that communicate data by using modulated electromagnetic radiation through a non-solid medium. A wireless device may comprise at least one antenna, at least one radio, at least one memory, at least one processor, and subcomponents of any of these, where the radio(s) transmits signals through the antenna that represent data and receives signals through the antenna that represent data, while the processor(s) may process the data to be transmitted and the data that has been received. The processor(s) may also process other data which is neither transmitted nor received.

As used within this document, the term ‘access point’ (AP) is intended to cover devices that schedule and control, at least partially, wireless communications by other devices in the network. An AP may also be known as a base station (BS), network controller (NC), central point (CP), or any other term that may arise to describe the functionality of an AP.

As used within this document, the term ‘station’ (STA) is intended to cover those devices whose wireless communications are at least partially scheduled and controlled by the AP. A STA may also be known as a mobile station (MS), mobile device (MD), subscriber station (SS), user equipment (UE), or any other term that may arise to describe the functionality of a STA. STAs may move during communications, but the capability for such movement is not required.

As used within this document, the term ‘communicate’ is intended to include transmitting and/or receiving. Similarly, the bidirectional exchange of data between two devices (both devices transmit and receive during the exchange) may be described as ‘communicating’, even if the functionality of only one of those devices is being claimed.

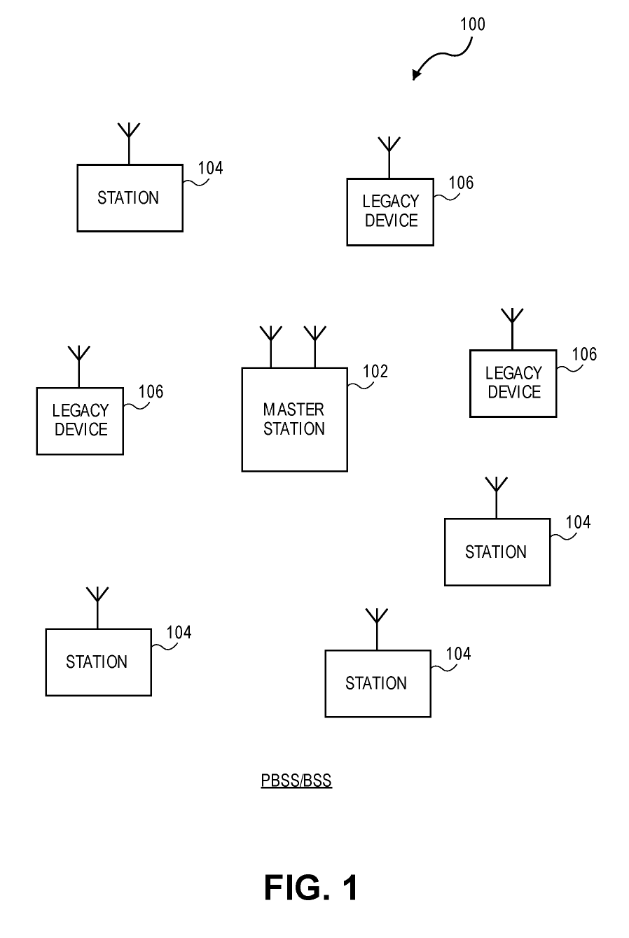

FIG. 1 illustrates a WLAN 100 in accordance with some embodiments. Devices and stations 102, 104, and 106 may each be considered a wireless communication device. The WLAN may comprise a basis service set (BSS) or personal BSS (PBSS) 100 that may include a master station 102, which may be an AP or PBSS control point (PCP), a plurality of wireless (e.g., IEEE 802.11ay) STAs 104 and a plurality of legacy (e.g., IEEE 802.11n/ac/ad) STAs 106.

The master station 102 may be an AP to provide overall network control of WLAN 100. The master station 102 may use other communications protocols as well as the IEEE 802.11 protocol. In some embodiments, the IEEE 802.11 protocol may be IEEE 802.11ay. The IEEE 802.11 protocol may include using orthogonal frequency division multiple-access (OFDMA), time division multiple access (TDMA), and/or code division multiple access (CDMA). The IEEE 802.11 protocol may include one or more multiple access techniques. For example, the IEEE 802.11 protocol may include space-division multiple access (SDMA), multiple-input multiple-output (MIMO), multi-user MIMO (MU-MIMO), and/or single-input single-output (SISO). The master station 102 and/or wireless STA 104 may be configured to operate in accordance with NG60, WiGiG, and/or IEEE 802.11ay.

The legacy devices 106 may operate in accordance with one or more of IEEE 802.11 a/b/g/n/ac/ad/af/ah/aj, or another legacy wireless communication standard. The legacy devices 106 may be STAs. The wireless STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ay or another wireless protocol. In some embodiments, the wireless STAs 104 may operate in accordance with IEEE 802.11ax. The STAs 104 and/or master station 102 may be attached to a BSS and may also operate in accordance with IEEE 802.11ay where one of the STAs 104 and/or master station 102 takes the role of the PCP.

The master station 102 may communicate with legacy devices 106 in accordance with legacy IEEE 802.11 communication techniques. In example embodiments, the master station 102 may also be configured to communicate with wireless STAs 104 in accordance with legacy IEEE 802.11 communication techniques. The master station 102 may use techniques of 802.11ad for communication with legacy device. The master station 102 may be a personal basic service set (PBSS) Control Point (PCP) which can be equipped with large aperture antenna array or Modular Antenna Array (MAA).

The master station 102 may be equipped with more than one antenna. Each of the antennas of master station 102 may be a phased array antenna with multiple elements. In some embodiments, an IEEE 802.11ay frame may be configurable to have the same bandwidth as a channel. The frame may be configured to operate over 1-4 2160 MHz channels. The channels may be contiguous.

An 802.11ay frame may be configured for transmitting a number of spatial streams, which may be in accordance with MU-MIMO. In other embodiments, the master station 102, wireless STA 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to 802.11ay communications. In accordance with some IEEE 802.11ay embodiments, a master station 102 may operate as a master station which may be arranged to contend for a wireless medium (e.g., during a contention period) to receive exclusive control of the medium for performing enhanced beamforming training for a multiple access technique such as OFDMA or MU-MIMO. In some embodiments, the multiple-access technique used during the TxOP (transmit opportunity) may be a scheduled OFDMA technique, although this is not a requirement. In some embodiments, the multiple access technique may be a space-division multiple access (SDMA) technique.

The master station 102 may also communicate with legacy stations 106 and/or wireless stations 104 in accordance with legacy IEEE 802.11 communication techniques.

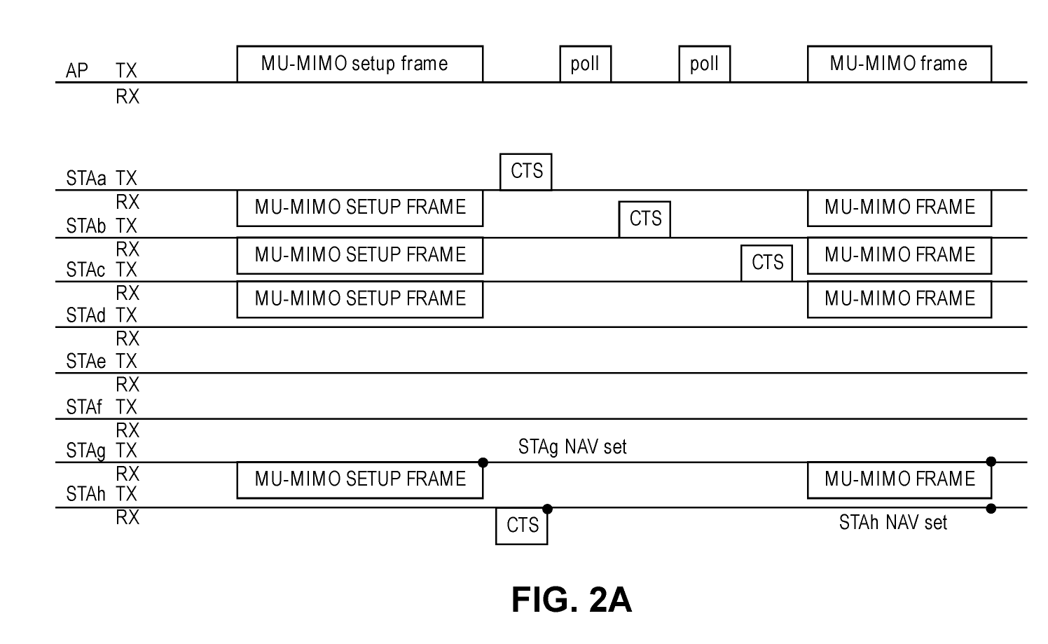

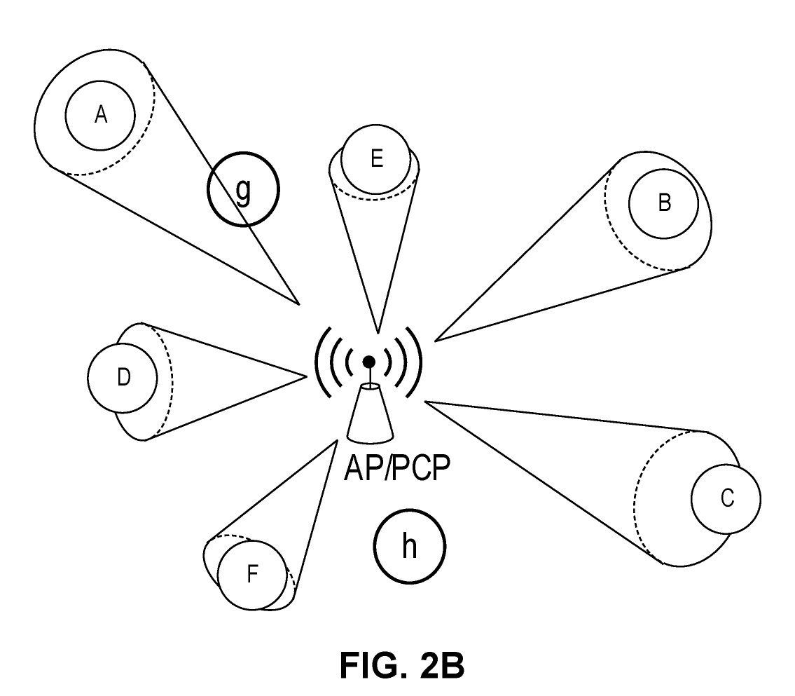

Referring to FIGS. 2A and 2B, in some embodiments an MU-MIMO setup frame (e.g., an MU-RTS frame) can be sent before the downlink (DL) MU-MIMO protocol data unit (PPDU). In some embodiments, this single frame can reach destination STAs even if their receive antennas are not beamformed toward the AP. This single frame may also indicate the destination to which STAs can be addressed by a DL MU-MIMO frame (e.g. antenna identification, or AID, of one or more destination STAs in MU-MIMO setup frame). In some embodiments, this single frame enables other STAs in the transmission direction to set their network allocation vector (NAV). For example, the frame can indicate the duration field in MU-MIMO setup frame and directional multi gigabit (DMG) PHY mode in accordance with some embodiments. The frame may also solicit Clear-to-Send (CTS) feedbacks.

When receiving the MU-MIMO setup frame in some embodiments, a destination STA may have the time to set its best (‘best” within the constraints of the beamforming training process) antenna weight vector (AWV). An AWV may be a set of parameters for a wireless communications device to apply to its antenna array to achieve directional communication. For example, in some embodiments, the best AWV may have an optimal receive sector configuration defined during the beamforming training process, which may take place before the MU-MIMO setup Frame of FIG. 2A. In some embodiments, to select which Rx AWV to use, a destination STA may need information on the origin of the packet and which other STA transmissions are scheduled at the same time (for example, a GroupID). For example, STA1could use different Rx AWVs if it is grouped with STA2-3 or if it is grouped with STA4-5-6 in accordance with some embodiments. When multi-user beamforming training allows it, STA1 can in some embodiments optimize its AWV to reduce interference from other STAs, for example by nulling the signal arriving from another direction. This nulling can relate to which STAs are simultaneously scheduled with downlink transmissions from the AP.

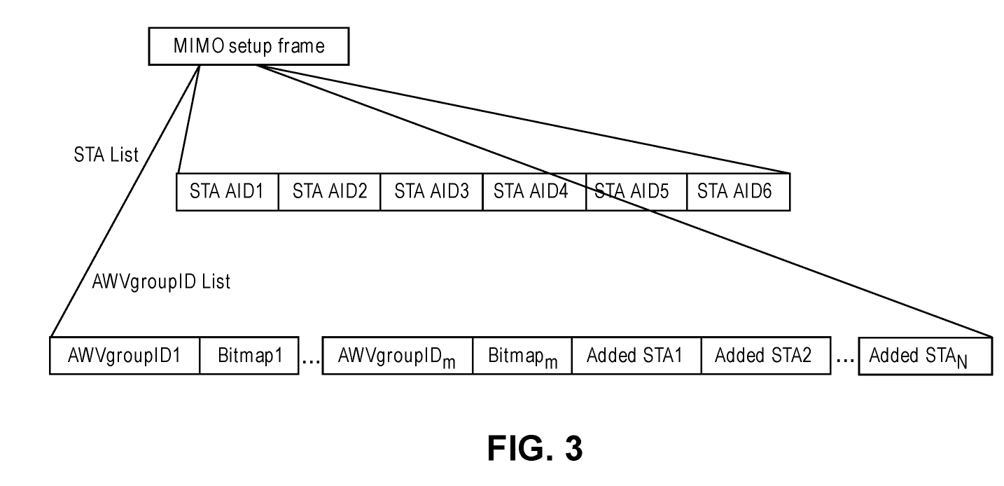

Referring to FIG. 3, a destination STA may have little time between the MU-MIMO setup frame and the MU-MIMO PPDU to tune its receiver to the best AWV. When there is a list of STA AIDs, as shown in the STA List of FIG. 3, the STA may have to read all of them, and then search which AWV to use based on the combination of STA AIDs in the setup frame and the associated AWVs stored in that STA. This may require the STA to perform a search and compare analysis to arrive at a preferable AWV. A latency issue and a storage issue on the STA side can arise as a result. Further, the list of destination STAs may not correspond exactly to the STAs that have been trained together, and there can therefore be ambiguity as to which AWV the STA should use.

The AWVgroupID List of FIG. 3 shows a solution to this problem by creating multiple groups called AWVgroupIDs. Each such AWVgroupID may be associated with one or more STA AIDs that are destination STAs of the setup frame, and further, identify which AWV to use.

For example, a groupID referred to as AWVgroupID can be used to identify a group of one or more STAs that can be the destination STAs of the MU-MIMO setup frame. This AWVgroupID can allow the receivers to identify directly: (1) that they are the intended recipient of the MU-MIMO setup frame; and/or (2) what AWV to use for a subsequent downlink reception.

To generate the AWVgroupIDs, some embodiments may assign an AWVgroupID to each STA during multi-user beamforming training. If MU-MIMO beamforming training is used, the AP may indicate an AWVgroupID that identifies: (1) a group of destination STAs that have performed beamforming training jointly; and/or (2) an optimal AWV for each STA to use when these STAs are grouped together for a future MU-MIMO PPDU transmission. In some embodiments, this information may be stored in each STA for reference when the STA receives an AWVgroupID that includes that STA in the MU-MIMO setup frame.

If single user (SU) beamforming training is performed, in some embodiments the AP can indicate an AWVgroupID that can identify: (1) a single STA that has performed beamforming training; and/or a preferable AWV that this STA can use when addressed by this AWVgroupID. After beamforming training, the STA can in some embodiments store the best AWV and associate it with the associated AWVgroupID. In some embodiments, the AWVgroupID may be used in the training phase, either to identify the STAs, or to associate this AWVgroupID with the AWVs that have been chosen by the beamforming training. Alternatively, the AWVgroupID can be assigned by frame exchange independently of the training phases

Again referring to FIG. 3, the AP may transmit an MU-MIMO setup frame to multiple STAs prior to transmitting the MU-MIMO frame. In some embodiments, the MU-MIMO setup frame may include one or more AWVgroupIDs. The receiver STA can detect the AWVgroupIDs and identify if the receiver STA is associated with one of the received AWVgroupIDs, and determine what AWV to use.

In some embodiments, if an AWVgroupID is included in a MIMO setup frame, there may be no need to include a list of STA AIDs. The flexibility of an AWVGroupID in a MIMO setup frame can be increased, for example, by adding a Bitmap field to identify the STAs of the group that are addressed and the STAs that are not. The suppression of some STAs from the group by a bitmap field may not necessarily impact the selection of the AWV. The flexibility of an AWVGroupID in MIMO setup frame may also be increased by adding STA addresses to the group, but this may not change the AWVs of the STAs in the group. As shown in FIG. 3, the MIMO setup frame may include multiple AWVGroupIDs. In some embodiments, a bitmap per AWVgroupID (see FIG. 3) may be used to ensure that the STA is present in only one of the groups. For example, if the STA is associated with multiple AWVgroupIDs, only one of the various bitmaps can show that STA as being indicated. Alternately, if there are not enough AWVgroupIDs to encompass all possible combinations of STAs, a bitmap may be used to indicate the particular STAs being indicated for that group.

In some embodiments, an AWVID can be assigned to each STA during beamforming training. For example, when a STA performs beamforming training, either in SU or MU mode, it may define a preferred Rx AWV. This preferred Rx AWV can be assigned an ID called an AWVID. This can be useful not only for MU-MIMO, but also for single user (SU)-MIMO, or SU-single-input and single output (SU-SISO), for example, when one or more beamforming trainings have occurred and have led to different AWVs

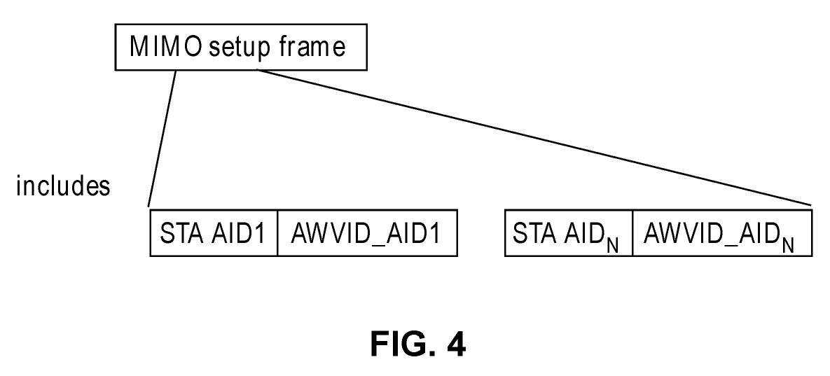

FIG. 4 illustrates a MIMO setup frame that can be transmitted to one or more STAs, where the MIMO setup frame includes a list of STA AIDs, along with which AWV each STA should use in a subsequent MU-MIMO downlink communication, in accordance with embodiments. Each AWV may have been previously determined to be the best AWV for the associated STA to use when communicating simultaneously with the other STAs in the setup frame. The AP may make this determination of which AID/AWV combination is best for each STA based on results of previous beamforming training.

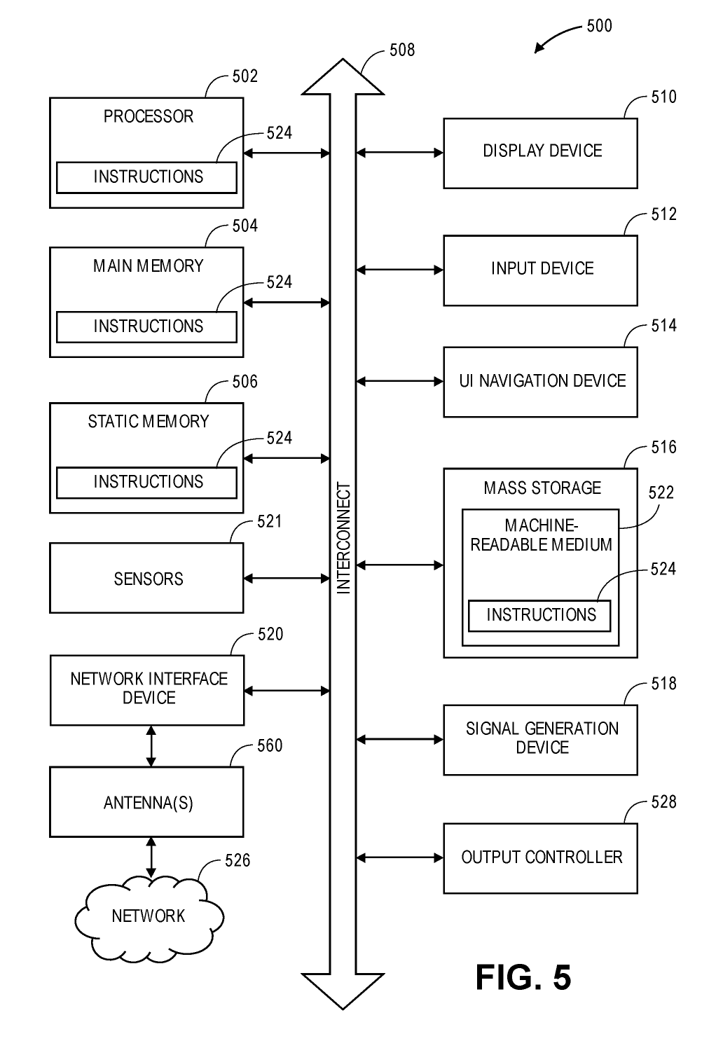

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a master station 102, HE station 104, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display device 510, an input device 512 (e.g., a keyboard), and a user interface (UI) navigation device 514 (e.g., a mouse). In an example, the display device 510, input device 512 and UI navigation device 514 may be a touch screen display. The machine 500 may additionally include a mass storage (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 502 and/or instructions 524 may comprise processing circuitry and/or transceiver circuitry.

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

An apparatus of the machine 500 may be one or more of a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: nonvolatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer to-peer (P2P) networks, among others.

In an example, the network interface device 520 may include one or more physical jacks (e.g., Ethernet, coaxial, or phone jacks) or one or more antennas to connect to the communications network 526. In an example, the network interface device 520 may include one or more antennas 860 to wirelessly communicate using at least one of single-input multiple-output (SIMO), multiple input multiple-output (MIMO), or multiple-input single-output (MISO) techniques. In some examples, the network interface device 520 may wirelessly communicate using Multiple User MIMO techniques. The term “transmission medium” shall be taken to include any intangible medium that is capable of storing, encoding or carrying instructions for execution by the machine 500, and includes digital or analog communications signals or other intangible medium to facilitate communication of such software.

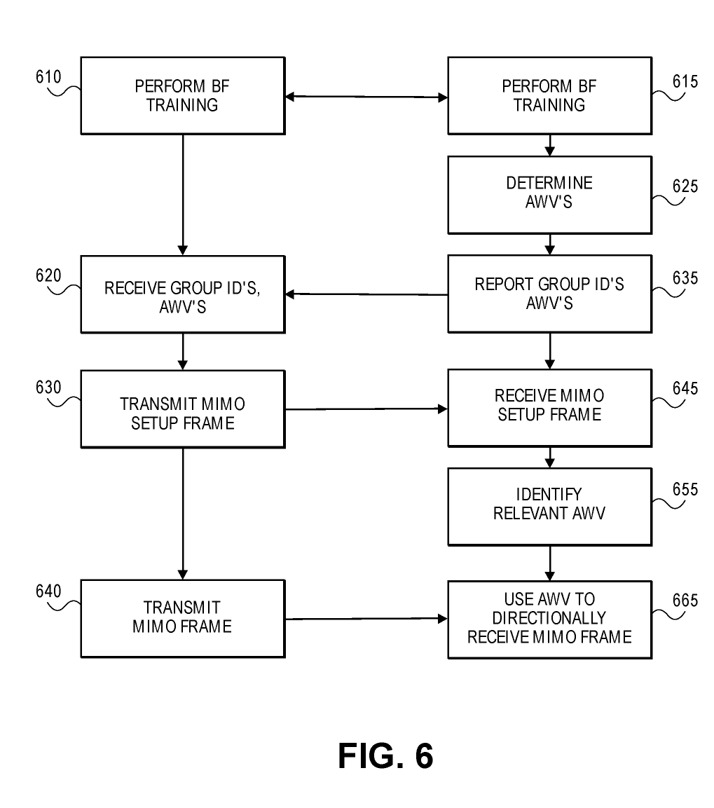

FIG. 6 shows a flow diagram of a method, in accordance with some embodiments. FIG. 6 shows one AP and one STA, but the same interaction may take place between one AP and multiple STAs.

The illustrated process may begin at 610 and 615 when the AP and STA perform beamforming training so that the STA can derive an Antenna Weight Vector at 625 for subsequent directional receipt of communications from the AP. In some embodiments the AP may also assign a Group ID to the STA during the beamforming process. At 635, the STA may report its AWV to the AP, which the AP may receive at 620, while in other embodiments the STA may simply store the value of its AWV for later use. In some embodiments the STA may report its assigned GroupID to the AP, while in other embodiments the AP may simply remember that Group ID assignment.

At 630 the AP may transmit a MIMO Setup Frame to the STA, which is received at 645. As previously described in this document, the Setup Frame may contain the STAID and/or the MIMOgroupID that indicates this STA, and/or the AWV for use by this STA. Based on this information and possibly on the information previously stored, the STA can determine at 655 the AWV to be used for directional reception of a subsequent MIMO communication from the AP. This MIMO frame may then be communicated from the AP to the STA at 640 and 665. In this manner, the STA may use directional reception to increase the gain of this received signal and possibly reduce the effects of signals received from other devices.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

### EXAMPLES

The following examples pertain to particular embodiments.

Example 1 includes a wireless communications device having a processor and a memory, the processor and memory adapted to: encode a multiple-input multiple-output (MIMO) setup frame that includes multiple group identifiers, each group identifier associated with multiple station (STA) address identifiers, each of the multiple STA address identifiers associated with an antenna weight vector (AWV) for directional reception; and transmit the MIMO setup frame to multiple STAs associated with the multiple STA address identifiers.

Example 2 includes the wireless communications device of example 1, further adapted to append a bitmap to each group identifier to indicate which of the multiple STA address identifiers to associate with each group identifier.

Example 3 includes the wireless communications device of example 1, further adapted to enable determination of the AWVs by performing beamforming training with the STAs prior to said encoding and transmitting.

Example 4 includes the wireless communications device of example 1, further comprising an antenna array.

Example 5 includes a method of wireless communications, comprising encoding a multiple-input multiple-output (MIMO) setup frame that includes multiple group identifiers, each group identifier associated with multiple station (STA) address identifiers, each of the multiple STA address identifiers associated with an antenna weight vector (AWV) for directional reception; and transmitting the MIMO setup frame to multiple STAs associated with the multiple STA address identifiers.

Example 6 includes the method of example 5, further comprising appending a bitmap to each group identifier to indicate which of the multiple STA address identifiers to associate with each group identifier.

Example 7 includes the method of example 5, further comprising enabling determination of the AWVs by performing beamforming training with the STAs prior to said encoding and transmitting.

Example 8 includes a computer-readable non-transitory storage medium that contains instructions, which when executed by one or more processors result in performing operations comprising encoding a multiple-input multiple-output (MIMO) setup frame that includes multiple group identifiers, each group identifier associated with multiple station (STA) address identifiers, each of the multiple STA address identifiers associated with an antenna weight vector (AWV); and transmitting the MIMO setup frame to multiple STAs associated with the multiple STA address identifiers.

Example 9 includes the medium of example 8, wherein the operations further comprise appending a bitmap to each group identifier to indicate which of the multiple STA address identifiers to associate with each group identifier.

Example 10 includes the medium of example 8, wherein the operations further comprise enabling determination the AWVs by performing beamforming training with the STAs prior to said encoding and transmitting.

Example 11 includes a wireless communications device comprising means to encode a multiple-input multiple-output (MIMO) setup frame that includes multiple group identifiers, each group identifier associated with multiple station (STA) address identifiers, each of the multiple STA address identifiers associated with an antenna weight vector (AWV); and transmit the MIMO setup frame to multiple STAs associated with the multiple STA address identifiers.

Example 12 includes the device of example 11, further comprising means to append a bitmap to each group identifier to indicate which of the multiple STA address identifiers to associate with each group identifier.

Example 13 includes the device of example 11, further comprising means to enable determination of the AWVs by performing beamforming training with the STAs prior to said encoding and transmitting.

Example 14 includes a wireless communications device comprising a processor and a memory, the processor and memory adapted to encode a multiple-input multiple-output (MIMO) setup frame that includes multiple station (STA) address identifiers; encode the MIMO setup frame with multiple antenna weight vectors (AWV), each AWV associated with one of the STA address identifiers; transmit the MIMO setup frame to multiple STAs associated with the multiple STA address identifiers; and transmit, subsequent to said transmitting the MIMO setup frame, a MIMO frame to the STAs identified by the STA address identifiers; wherein each AWV represents directional receive parameters for the associated STA during the MIMO frame.

Example 15 includes the wireless communications device of example 14, further adapted to perform beamforming training with the multiple STAs prior to said encoding the MIMO setup frame to permit deriving the AWVs.

Example 16 includes the wireless communications device of example 14, further comprising an antenna array.

Example 17 includes a method of wireless communication, comprising encoding a multiple-input multiple-output (MIMO) setup frame that includes multiple station (STA) address identifiers; encoding the MIMO setup frame with multiple antenna weight vectors (AWV), each AWV associated with one of the STA address identifiers; transmitting the MIMO setup frame to multiple STAs associated with the multiple STA address identifiers; and transmitting, subsequent to said transmitting the MIMO setup frame, a MIMO frame to the STAs identified by the STA address identifiers; wherein each AWV represents directional receive parameters for the associated STA during the MIMO frame.

Example 18 includes the method of example 17, further comprising performing beamforming training with the multiple STAs prior to said encoding the MIMO setup frame to permit deriving the AWVs.

Example 19 includes a computer-readable non-transitory storage medium that contains instructions, which when executed by one or more processors result in performing operations comprising encoding a multiple-input multiple-output (MIMO) setup frame that includes multiple station (STA) address identifiers; encoding the MIMO setup frame with multiple antenna weight vectors (AWV), each AWV associated with one of the STA address identifiers; transmitting the MIMO setup frame to multiple STAs associated with the multiple STA address identifiers; and transmitting, subsequent to said transmitting the MIMO setup frame, a MIMO frame to the STAs identified by the STA address identifiers; wherein each AWV represents directional receive parameters for the associated STA during the MIMO frame.

Example 20 includes the medium of example 19, further comprising performing beamforming training with the multiple STAs prior to said encoding the MIMO setup frame to permit deriving the AWVs.

Example 21 includes a wireless communications device comprising means to encode a multiple-input multiple-output (MIMO) setup frame that includes multiple station (STA) address identifiers; encode the MIMO setup frame with multiple antenna weight vectors (AWV), each AWV associated with one of the STA address identifiers; transmit the MIMO setup frame to multiple STAs associated with the multiple STA address identifiers; and transmit, subsequent to said transmitting the MIMO setup frame, a MIMO frame to the STAs identified by the STA address identifiers; wherein each AWV represents directional receive parameters for the associated STA during the MIMO frame.

Example 22 includes the wireless communications device of example 21, further comprising means to perform beamforming training with the multiple STAs prior to said encoding the MIMO setup frame to permit deriving the AWVs.

Example 23 includes a wireless communications device having a processor and a memory, the processor and memory adapted to receive a multiple-input multiple-output (MIMO) setup frame that includes multiple group identifiers, wherein the wireless communications device has previously associated itself with one of the group identifiers; and use a previously determined antenna weight vector (AWV) to directionally receive a MIMO frame subsequent to said receiving the MIMO setup frame.

Example 24 includes the wireless communications device of example 23, further adapted to perform beamforming training prior to said receiving, to derive said AWV.

Example 25 includes the wireless communications device of example 24, further comprising an antenna array.

Example 26 includes a method of wireless communication, comprising receiving, by a wireless communications device, a multiple-input multiple-output (MIMO) setup frame that includes multiple group identifiers; determining the wireless communications device has previously associated itself with one of the group identifiers; and using a previously determined antenna weight vector (AWV) to directionally receive a MIMO frame subsequent to said receiving the MIMO setup frame.

Example 27 includes the method of example 26, wherein said previous association comprises using beamforming training to determine said AWV.

Example 28 includes a computer-readable non-transitory storage medium that contains instructions, which when executed by one or more processors result in performing operations comprising receiving, by a wireless communications device, a multiple-input multiple-output (MIMO) setup frame that includes multiple group identifiers; determining the wireless communications device has previously associated itself with one of the group identifiers; and using a previously determined antenna weight vector (AWV) to directionally receive a MIMO frame subsequent to said receiving the MIMO setup frame.

Example 29 includes the medium of example 28, wherein said previous association comprises using beamforming training to determine said AWV.

Example 30 includes a wireless communications device having means to receive a multiple-input multiple-output (MIMO) setup frame that includes multiple group identifiers, wherein the wireless communications device has previously associated itself with one of the group identifiers; and use a previously determined antenna weight vector (AWV) to directionally receive a MIMO frame subsequent to said receiving the MIMO setup frame.

Example 31 includes the wireless communications device of example 30, further comprising means to perform beamforming training prior to said receiving, to derive said AWV.

Example 32 includes a wireless communications device comprising a processor and a memory, the processor and memory adapted to receive a multiple-input multiple-output (MIMO) setup frame that is to include multiple station (STA) address identifiers and multiple antenna weight vectors (AWVs), each of the STA address identifiers being associated with one of the AWVs; determine that one of the STA address identifiers is a particular STA address identifier that identifies the wireless communications device; and receive, subsequent to said receiving the MIMO setup frame, a MIMO frame using an AWV associated with the particular STAs address identifier; wherein the AWV associated with the particular STA address identifier is to represent directional receive parameters for the wireless communications device.

Example 33 includes the wireless communications device of example 32, further adapted to perform beamforming training to derive the AWV associated with the wireless communications device, prior to said receiving the MIMO setup frame.

Example 34 includes the wireless communications device of example 32, further comprising an antenna array.

Example 35 includes a method of wireless communication, comprising receiving a multiple-input multiple-output (MIMO) setup frame that includes multiple station (STA) address identifiers and multiple antenna weight vectors (AWVs), each of the STA address identifiers being associated with one of the AWVs; determining that one of the STA address identifiers is a particular STA address identifier that identifies the wireless communications device; and receiving, subsequent to said receiving the MIMO setup frame, a MIMO frame using an AWV associated with the particular STAs address identifier; wherein the AWV associated with the particular STA address identifier represents directional receive parameters for the wireless communications device.

Example 36 includes the method of example 35, further comprising performing beamforming training to derive the AWV associated with the wireless communications device, prior to said receiving the MIMO setup frame.

Example 37 includes a computer-readable non-transitory storage medium that contains instructions, which when executed by one or more processors result in performing operations comprising receiving a multiple-input multiple-output (MIMO) setup frame that includes multiple station (STA) address identifiers and multiple antenna weight vectors (AWVs), each of the STA address identifiers being associated with one of the AWVs; determining that one of the STA address identifiers is a particular STA address identifier that identifies the wireless communications device; and receiving, subsequent to said receiving the MIMO setup frame, a MIMO frame using an AWV associated with the particular STAs address identifier; wherein the AWV associated with the particular STA address identifier represents directional receive parameters for the wireless communications device.

Example 38 includes the medium of example 37, wherein the operations further comprise performing beamforming training to derive the AWV associated with the wireless communications device, prior to said receiving the MIMO setup frame.

Example 39 includes a wireless communications device comprising means to receive a multiple-input multiple-output (MIMO) setup frame that is to include multiple station (STA) address identifiers and multiple antenna weight vectors (AWVs), each of the STA address identifiers being associated with one of the AWVs; determine that one of the STA address identifiers is a particular STA address identifier that identifies the wireless communications device; and receive, subsequent to said receiving the MIMO setup frame, a MIMO frame using an AWV associated with the particular STAs address identifier; wherein the AWV associated with the particular STA address identifier is to represent directional receive parameters for the wireless communications device.

Example 40 includes the wireless communications device of example 32, further comprising means to perform beamforming training to derive the AWV associated with the wireless communications device, prior to said receiving the MIMO setup frame.

The foregoing description is intended to be illustrative and not limiting. Variations will occur to those of skill in the art. Those variations are intended to be included in the various embodiments of the invention, which are limited only by the scope of the following claims.

What is claimed is:

1. A wireless communications device having a processor and a memory, the processor and memory adapted to:
encode a multiple-input multiple-output (MIMO) setup frame that includes multiple group identifiers, each group identifier associated with multiple station (STA) address identifiers, each of the multiple STA address identifiers associated with an antenna weight vector (AWV) for directional reception; and
transmit the MIMO setup frame to multiple STAs associated with the multiple STA address identifiers.

2. The wireless communications device of claim 1, further adapted to append a bitmap to each group identifier to indicate which of the multiple STA address identifiers to associate with each group identifier.

3. The wireless communications device of claim 1, further adapted to enable determination of the AWVs by performing beamforming training with the STAs prior to said encoding and transmitting.

4. The wireless communications device of claim 1, further adapted to transmit a MIMO frame to the multiple STAs subsequent to said transmitting the MIMO setup frame.

5. The wireless communications device of claim 1, further comprising an antenna array.

6. A computer-readable non-transitory storage medium that contains instructions, which when executed by one or more processors result in performing operations comprising:
encoding a multiple-input multiple-output (MIMO) setup frame that includes multiple group identifiers, each group identifier associated with multiple station (STA) address identifiers, each of the multiple STA address identifiers associated with an antenna weight vector (AWV); and
transmitting the MIMO setup frame to multiple STAs associated with the multiple STA address identifiers.

7. The medium of claim 6, wherein the operations further comprise appending a bitmap to each group identifier to indicate which of the multiple STA address identifiers to associate with each group identifier.

8. The medium of claim 6, wherein the operations further comprise transmitting a MIMO frame to the multiple STAs subsequent to said transmitting the MIMO setup frame.

9. The medium of claim 6, wherein the operations further comprise enabling determination the AWVs by performing beamforming training with the STAs prior to said encoding and transmitting.

10. A wireless communications device comprising a processor and a memory, the processor and memory adapted to:
encode a multiple-input multiple-output (MIMO) setup frame that includes multiple station (STA) address identifiers;
encode the MIMO setup frame with multiple antenna weight vectors (AWV), each AWV associated with one of the STA address identifiers; and
transmit the MIMO setup frame to multiple STAs associated with the multiple STA address identifiers;
wherein each AWV represents directional receive parameters for the associated STA to use during communication of a subsequent MIMO frame.

11. The wireless communications device of claim 10, further adapted to transmit, subsequent to said transmitting the MIMO setup frame, the MIMO frame to the STAs identified by the STA address identifiers.

12. The wireless communications device of claim 10, further adapted to:
perform beamforming training with the multiple STAs prior to said encoding the MIMO setup frame to permit deriving the AWVs.

13. The wireless communications device of claim 10, further comprising an antenna array.

14. A computer-readable non-transitory storage medium that contains instructions, which when executed by one or more processors result in performing operations comprising:
encoding a multiple-input multiple-output (MIMO) setup frame that includes multiple station (STA) address identifiers;
encoding the MIMO setup frame with multiple antenna weight vectors (AWV), each AWV associated with one of the STA address identifiers; and
transmitting the MIMO setup frame to multiple STAs associated with the multiple STA address identifiers;
wherein each AWV represents directional receive parameters for the associated STA during the MIMO frame.

15. The medium of claim 14, wherein the operations further comprise transmitting, subsequent to transmitting the MIMO setup frame, a MIMO frame to the STAs identified by the STA address identifiers.

16. The medium of claim 14, further comprising performing beamforming training with the multiple STAs prior to said encoding the MIMO setup frame to permit deriving the AWVs.

17. A wireless communications device having a processor and a memory, the processor and memory adapted to:
receive a multiple-input multiple-output (MIMO) setup frame that includes multiple station (STA) address identifiers and multiple antenna weight vectors (AWVs), each of the STA address identifiers being associated with one of the AWVs;
determine that one of the STA address identifiers is a particular STA address identifier that identifies the wireless communications device; and
receive, subsequent to said receiving the MIMO setup frame, a MIMO frame using an AWV associated with the particular STAs address identifier;
wherein the AWV associated with the particular STA address identifier represents directional receive parameters for the wireless communications device.

18. The wireless communications device of claim 17, further comprising an antenna array.

19. A computer-readable non-transitory storage medium that contains instructions, which when executed by one or more processors result in performing operations comprising:
receiving a multiple-input multiple-output (MIMO) setup frame that includes multiple station (STA) address identifiers and multiple antenna weight vectors (AWVs), each of the STA address identifiers being associated with one of the AWVs;
determining that one of the STA address identifiers is a particular STA address identifier that identifies the wireless communications device; and
receiving, subsequent to said receiving the MIMO setup frame, a MIMO frame using an AWV associated with the particular STAs address identifier;
wherein the AWV associated with the particular STA address identifier represents directional receive parameters for the wireless communications device.

20. The medium of claim 19, wherein the operations further comprise performing beamforming training to derive the AWV associated with the wireless communications device, prior to said receiving the MIMO setup frame.
